(19) United States
(12) Patent Application Publication
(10) Pub. No.: US 2011/0048857 A1
(43) Pub. Date: Mar. 3, 2011

(54) LUBRICATION SYSTEM

(75) Inventors: Andrew N. McGilvray, Ketton (GB); Pinghui Wang, Dunlap, IL (US); Dongyun Hua, Peoria, IL (US)

(73) Assignee: CATERPILLAR INC., Peoria, IL (US)

(21) Appl. No.: 12/551,621

(22) Filed: Sep. 1, 2009

(51) Int. Cl. F16N 39/00; F16H 57/04

(52) U.S. Cl. 184/6.12; 184/6.21

(57) ABSTRACT

In one aspect a method for lubricating a tribosystem is provided that may include providing a new tribosystem including at least two solid surfaces that interact during operation of the tribosystem and providing lubrication oil for lubricating the tribosystem. The method may further include operating the tribosystem while lubricating the tribosystem with the lubrication oil during an initial period and supplying anti-wear additives to the lubrication oil at the end of the initial period. In another aspect a lubrication assembly for containing lubrication oil may be provided. The lubrication assembly may include an anti-wear additive storage and a releaser that is configured for releasing anti-wear additive from the anti-wear additive storage into the lubrication oil after an initial period of operation.

### TECHNICAL FIELD

The present disclosure relates to a lubrication system for a tribosystem.

### BACKGROUND

A tribosystem is a mechanical system having at least two solid surfaces that make contact and while making contact move relative to each other. Examples of tribosystems are numerous and include bearings, gears and piston/cylinder-systems. Normally, the load on a tribosystem is not constant but is cyclic. These cyclic loads lead to so-called stress cycles on the solid surfaces of the tribosystem that make contact. For example, a stress cycle occurs on a tooth flank of a gear when the tooth flank meshes with another tooth flank.

When a new tribosystem is put into use and when the at least two solid surfaces of the tribosystem are brought together under load and moved relative to one another, the surface topography of the solid surfaces changes resulting in a change of surface roughness. This process is usually accompanied by changes in macroscopic friction force and rates of wear. This period of change in macroscopic friction force and change of rates of wear is known as “running-in” or “break-in”. After the break-in period, the tribosystem reaches a condition wherein the average kinetic friction coefficient, the wear rate and possibly other specified parameters have reached a relatively constant level and maintain that level. On micro-scale the surface topography and the surface roughness have reached a relatively constant level and maintain that level. That condition is known as “steady state”. The break-in period includes those processes which occur prior to the steady state period. Another term that is known in this field is “wear-in”. Wear-in includes the wear processes that precede the acquisition of a steady state rate of wear.

Wear of material may have various forms. Asperity truncation is a wear process by which the tops of tiny surface projections are sheared-off. Asperity truncation is often associated with the micro-geometric conformation that occurs during the wear-in. Asperity truncation results in polishing wear. Micropitting is a wear process that results from fatigue on a microscale and that includes the formation of tiny pits in the surfaces and spall. It usually indicates the beginning of surface distress.

Normally, tribosystems are lubricated with lubrication oil. Lubrication oil is provided to cool a tribosystem and to reduce the friction between and the wear of the solid surfaces that make contact and move relative to each other. Numerous different types of lubrication oil are known. Especially for tribosystems that are subject to high loads, such as gears that have to transmit high power while rotating at relatively low speed, the lubrication oil used in many cases contains anti-wear additives. The general term “anti-wear additives” also may include extreme pressure additives. Generally, anti-wear additives reduce the wear of the solid surfaces of the tribosystem. Examples of anti-wear additives are Zinc dithiophosphate (ZDP), Zinc dialkyldithiophosphate (ZDDP or ZDTP), Molybdenum disulphide (MoDS), Molybdenum dialkyldithiocarbamate (MoDTC). Research is currently directed to finding better anti-wear additives that have even better properties in reducing wear of tribosystems. However, wear of tribosystems remains a concern and the present disclosure is directed, at least in part, to improving or overcoming one or more aspects of prior lubrication systems.

### SUMMARY OF THE INVENTION

In one aspect a method for lubricating a tribosystem is provided that may include providing a new tribosystem including at least two solid surfaces that interact during operation of the tribosystem and providing lubrication oil for lubricating the tribosystem. The method may further include operating the tribosystem while lubricating the tribosystem with the lubrication oil during an initial period and supplying anti-wear additives to the lubrication oil at the end of the initial period.

In another aspect a lubrication assembly for containing lubrication oil may be provided. The lubrication assembly may include an anti-wear additive storage and a releaser that is configured for releasing anti-wear additive from the anti-wear additive storage into the lubrication oil after an initial period of operation.

### BRIEF DESCRIPTION OF THE DRAWINGS

FIG. 1 is a schematic representation of a first embodiment of an assembly including a tribosystem and a lubrication assembly; and

FIG. 2 is a schematic representation of a second embodiment of an assembly including a tribosystem and a lubrication assembly;

### DETAILED DESCRIPTION

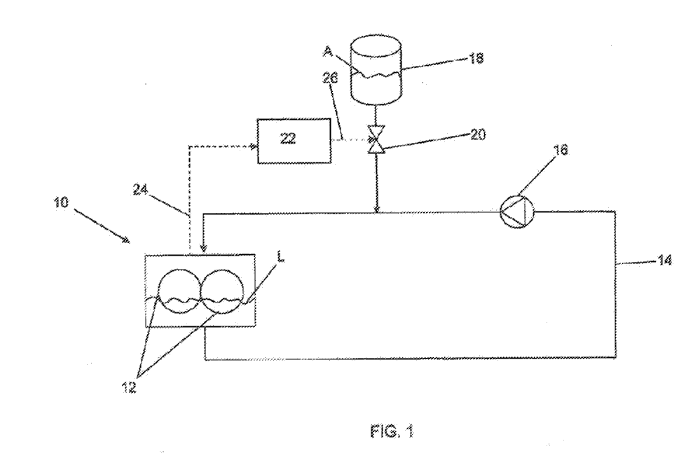

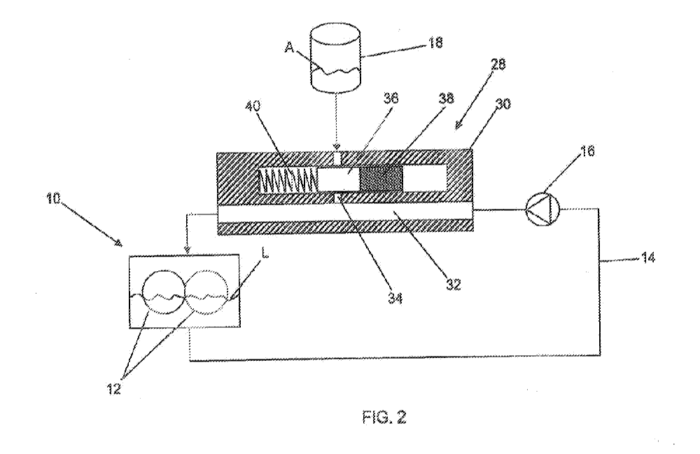

A lubrication assembly, of which examples are shown in FIGS. 1 and 2, may be used for supplying lubrication oil L to a tribosystem 10. The tribosystem 10 may be of any kind and may include at least two solid surfaces 12 that interact when the tribosystem 10 is in operation. The interaction of the at least two solid surfaces 12 may include contacting, transmitting force and moving relative to each other. The solid surfaces 12 may be the teeth surfaces of gears or the bearing surfaces of bearings or the contact surfaces of piston rings and cylinders or any other mechanical assembly of solid surfaces 12 that may move relative to each other, may contact each other and may exert a force onto each other.

The lubrication assembly may include piping 14 and a pumping device 16. The piping may contain lubrication oil L that may be supplied to the tribosystem 10 by the pumping device 16. Although not necessary, the piping 14 may form a circuit including the tribosystem 10 and the pumping device 16. The circuit may also include an oil reservoir, an oil cooler, an oil filter and many other components that may require lubrication and/or cooling. On the other hand, the lubrication assembly may also simply include a lubrication oil reservoir in which the tribosystem 10 operates. The solid surfaces 12 of the tribosystem 10 may be partly or periodically immersed in the lubrication oil L contained in the reservoir. In such a lubrication assembly, piping 14 and pumping device 16 may not be present.

The lubrication assembly may further include an anti-wear additive storage 18 and a releaser 20 configured for releasing anti-wear additive A from the anti-wear additive storage 18 into the lubrication oil L after an initial period of operation.

A controller 22 may be provided for controlling the releaser 20. In the embodiment of FIG. 1, the releaser 20 is shown as a valve 20 that may be controlled by the controller 22. The controller 22 may be connected to the tribosystem 10 via signal line 24 and may be connected to the releaser 20 via signal line 26. The controller 22 may be of electronic, pneumatic, hydraulic or mechanic type.

The releaser 20 may be integrated in a housing of the tribosystem 10. Also the anti-wear additive storage 18 may be integrated in a housing of the tribosystem 10. The releaser 20 and the anti-wear additive storage 18 may also be one integrated assembly. The controller 22 may be a part of such an integrated assembly. The controller 22 may, for example, be connected to an electronic motor controller of, for example, a combustion engine or an electric motor. Generally, such electronic motor controller also monitors the rotation of the engine or the electric motor. The rotation of the engine or motor may correlate to the number of stress cycles the tribosystem 10 makes. Alternatively, the electronic motor controller may also include the function of the controller 22, i.e.: controlling the releaser 20.

The embodiment of FIG. 2 also shows a lubrication assembly for lubricating a tribosystem 10 including solid surfaces 12. As in the embodiment of FIG. 1, the lubrication assembly may include piping 14, a pumping device 16, an anti-wear additive storage 18 and a releaser 28. The releaser 28 may include a housing 30 that may incorporate a lubrication oil passage 32. An inlet of the lubrication oil passage 32 may be connected to the piping 14 and an outlet of the lubrication oil passage 32 may be connected to the piping 14 as well. The housing 30 of the releaser 28 may also include an anti-wear additive passage 34 that has an inlet that is in fluid communication with the anti-wear additive storage 18 and an outlet that is in fluid communication with the lubrication oil L of the lubrication assembly, for example because the passage 34 emanates into the lubricating oil passage 32. The additive passage 34 may be closed off by a valve 36. In the embodiment shown in FIG. 2, the valve 36 includes a plunger. However, also other types of valve members are feasible such as a membrane valve, a poppet valve and a swivel valve and the like. A temperature sensitive member 38 and a biasing member 40 may be provided. The temperature sensitive member 38 may be configured to melt or soften above a release temperature value.

Alternatively, the temperature sensitive member may also be a temperature sensor that generates a temperature signal. Such a variant may be better represented by FIG. 1. The temperature signal may be provided to a controller 22 and the controller 22 may operate the releaser 20 to open when the temperature has reached a release temperature value.

The housing 30 of the releaser 28 may be an integral part of a housing of tribosystem 10. In such an embodiment, it may be that lubrication passage 32 is not present and that the outlet of anti-wear additive passage 34 emanates directly into a space that contains the lubrication oil L that lubricates the solid surfaces 12 of the tribosystem 10, for example, the oil reservoir. Alternatively, the housing 30 may also be an integral part of the anti-wear additive storage 18. In such an embodiment, an inlet of anti-wear passage 34 may emanate into a storage space of the anti-wear additive storage 18. Further, the anti-wear additive storage 18, the releaser 28 and a housing of the tribosystem 10 may be an integral part.

As is clear from the above, the lubrication assembly may just include an anti-wear additive storage 18 and a releaser 20 or 28 configured for releasing anti-wear additive A from the anti-wear additive storage 18 into the lubrication oil L after an initial period of operation. Such a lubrication assembly may be part of an assembly including a tribosystem 10. For example, the anti-wear additive storage 18 and the releaser 20, 28 may be an integral part of a special oil filter. The special oil filter may be mounted on the lubrication assembly when the lubrication assembly is produced.

### INDUSTRIAL APPLICABILITY

A lubrication assembly including an anti-wear additive storage 18 and a releaser 20, 28 may be applied for lubricating any kind of tribosystem 10. The tribosystem 10 to be lubricated by the lubrication assembly may for example be a gear assembly, a bearing assembly, a cylinder/piston-assembly or any other mechanical assembly in which solid surfaces 12 may contact each other, may move relative to each other and may exert a force onto each other.

For improved lubrication a method may be provided that may include providing a new tribosystem 10 including at least two solid surfaces 12 that interact during operation of the tribosystem 10. The method may further include providing lubrication oil L for lubricating the tribosystem 10 and operating the tribosystem 10 while lubricating the tribosystem 10 with the lubrication oil L during an initial period. At the end of the initial period anti-wear additives A may be supplied to the lubrication oil L. The anti-wear additives may also include extreme pressure additives. In the context of the present disclosure, the term “anti-wear additive” also includes extreme pressure additive. The anti-wear additives A may include at least one of molybdenum, zinc, phosphor and sulphur. Examples of anti-wear additives A are zinc dithiophosphate (ZDP), zinc dialkyldithiophosphate (ZDDP or ZDTP), molybdenum disulphide (MoDS) and molybdenum dialkyldithiocarbamate (MoDTC). The anti-wear additives A may be stored in the anti-wear additive storage 18 that may be part of the lubrication assembly. The lubrication oil L used during the initial period may have such a composition that it may allow polishing action of the at least two solid surfaces 12 of the tribosystem 10 during the initial period while micropitting of the at least two solid surfaces 12 during the initial period may be minimal. To that end, the lubrication oil L may contain no anti-wear additives A or may contain less anti-wear additives A than the lubrication oil L that is currently used for lubrication. The lubrication oil L used in the initial period may contain additives that may promote the polishing action.

Normally, the tribosystem 10 makes stress cycles when operated. Each time two solid surfaces 12 of a tribosystem 10 make contact and exert a force onto each other may constitute a stress cycle. For example for two meshing gears, the number of stress cycles may be determined by the number of rotations of the gears.

In one aspect, the end of the initial period may be determined on the basis of the number of stress cycles of the tribosystem 10. The number of stress cycles of the tribosystem 10 may be monitored after the tribosystem 10 has been put into operation for the first time. Such monitoring may, for example, include counting the number of full rotations of meshing gears or counting the number of full rotations of a shaft of which the bearings may constitute a tribosystem 10 to be lubricated by the lubrication assembly. To that end the tribosystem 10 may provide a signal over signal line 24 to controller 22. The signal may for example be supplied by an encoder mounted on a rotating part of the tribosystem 10 or of a rotating part of which the rotation is correlated with the rotation of the tribosystem 10. The signal may also be supplied by an electronic controller of a drive that drives the tribosystem 10. Such a drive may be an internal combustion engine or an electric drive. Controller 22 may provide a release signal via control line 26 to releaser 20. The release signal may operate the releaser 20 to release the anti-wear additives A from the anti-wear additive storage 18 into the lubrication oil L. The release signal may be provided by the controller 22 after the number of stress cycles has reached a release value. The release value may be in the range of 300.000-1.000.000 stress cycles. Tests have shown that after a number of stress cycles in that range, the polishing wear or break-in wear may have taken place. Asperity truncation, i.e. the process by which the tops of tiny surface projections are sheared-off may, by then, be sufficiently completed resulting in a desired geometric conformation of the interacting solid surfaces 12. On the other hand, micropitting may not yet have started. Tests have shown that micropitting will not or virtually not occur during break-in when no anti-wear additives A or less anti-wear additives A than currently customary are present in the lubrication oil L.

In yet another aspect, the end of the initial period may be determined on the basis of a time measurement. The amount of time during which the tribosystem 10 is operative after being put into operation for the first time, may be an indication of the extent of polishing wear that has taken place. Especially, in applications where the frequency of the stress cycles is substantially constant, time may be a good indicator for the amount of break-in wear. To that end, controller 22 may measure the time of operation of the tribosystem 10 after being put into use for the first time and on the basis of that the controller 22 may generate a release signal over signal line 26 to release the anti-wear additives A from the anti-wear additive storage 18 into the lubrication oil L when the initial period has been reached.

In yet another aspect, the end of the initial period may be determined on the basis of the temperature of the oil L. When a new tribosystem 10 is put into use for the first time, the lubrication oil L that may be used for lubricating the tribosystem 10 will initially have the temperature of the environment. As a consequence of the rotation of the tribosystem 10 the lubrication oil L may gradually raise in temperature. Consequently, the temperature of the lubrication oil L may be correlated to the time of initial operation of tribosystem 10. The raise in temperature of the lubrication oil L may be used to operate the releaser 28. In the embodiment shown in FIG. 2, the housing 30 of the releaser 28 will gradually raise in temperature because of the raising temperature of the lubrication oil L that contacts the housing 30. Initially, temperature sensitive member 38 may keep the valve 36 in the closed condition against the biasing member 40 biasing the valve 36 towards the open condition. As a consequence of the raising temperature of the housing 30, the temperature sensitive member 38 may soften or melt and may allow the valve 36 to move from the closed condition to the open condition. In the embodiment shown in FIG. 2, the biasing member 40 may push valve 36 in a position to the right side of the housing 30 wherein free passage of anti-wear additives A that are in anti-wear additive storage 18 through anti-wear passage 34 into the lubricating oil L is possible. Instead of a temperature sensitive member 38 that melts or softens, the temperature may also be monitored by a temperature sensor that may generate a temperature signal that may be provided to a controller 22. The controller 22 may control the releaser 20 to open when the temperature signal indicates a temperature that is at or above a release temperature.

In the exemplary embodiments described above, the supplying of anti-wear additives A to the lubrication oil L is performed automatically. However, it is also feasible that a controller 22 provides the user with a signal that indicates that anti-wear additives A have to be released into the lubrication oil L after an initial period of use. The user may then push a button, open a valve or perform any other operation to activate the releaser 20 to release the anti-wear additives A from the anti-wear additive storage 18 into the lubrication oil L.

As described above, the anti-wear additive storage 18 and the releaser 20, 28 may be part of a special oil filter of the lubrication assembly that may be mounted when the lubrication assembly is produced. When the lubrication assembly has to be serviced, the special oil filter may be replaced by a standard oil filter and the lubrication oil L may be replaced by lubrication oil L containing anti-wear additives A.

Tests have been performed in which a first solid surface, namely the cylindrical surface of a cylindrical object, has been brought into contact with another solid surface for a number of times while a force was transmitted between the surfaces and a relative movement between the surfaces was present, thus producing a corresponding number of stress cycles. In the following PAO stands for poly-α-olefin, i.e. a synthetic lubrication oil L without anti-wear additives. ZDDP is an anti-wear additive A and stands for zinc dialkyldithiophosphate. In a first test, lubrication oil L comprising anti-wear additives A was used directly from the start of using a new tribosystem 10. A severe wear occurred after approximately 1 million stress cycles. It is likely that this severe wear occurred due to micropitting of the solid surfaces in the break-in period. When in a second test under the same circumstances, PAO without anti-wear additives was used, the loss of diameter proved to be much less severe. When in a third test under the same circumstances, initially PAO without anti-wear additives as lubrication oil L was used and anti-wear additive A was introduced after a running-in period, the loss of diameter proved to be even lesser. By virtue of the anti-wear additives A that have been introduced after an initial period of break-in has elapsed, the wear on the long term may be reduced relative to the situation wherein standard PAO is used without anti-wear additives A and may also be reduced relative to the situation wherein a PAO with anti-wear additives is used from the beginning of the operation of the new tribosystem. Thus an improved result relative to the prior art lubrication systems may be obtained.

It will be apparent to those having ordinary skill in the art that various modifications and variations can be made to the disclosed lubrication system. Other embodiments will be apparent to those having ordinary skill in the art from consideration of the specification. It is intended that the specification and examples be considered as exemplary only. Other aspects, features and advantages will be apparent upon an examination of the attached drawings and appended claims.

1. A method for lubricating, the method including:
providing a new tribosystem including at least two solid surfaces that interact during operation of the tribosystem;
providing lubrication oil for lubricating the tribosystem;
operating the tribosystem while lubricating the tribosystem with the lubrication oil during an initial period;
supplying anti-wear additives to the lubrication oil at the end of the initial period.

2. The method of claim 1, wherein during the initial period the lubrication oil does not contain anti-wear additives.

3. The method of claim 1, wherein the lubrication oil used during the initial period has such a composition that it allows polishing action of the at least two solid surfaces of the tribosystem during the initial period while micropitting of the at least two solid surfaces during the initial period is minimal.

4. The method of claim 3, wherein the tribosystem makes stress cycles when operated and that the end of the initial period is determined on the basis of the number of stress cycles of the tribosystem.

5. The method of claim 4, including:
monitoring the number of stress cycles of the tribosystem after being made operative for the first time;
releasing the anti-wear additives in the lubrication oil after the number of stress cycles has reached a release value.

6. The method of claim 5, wherein the release value is in the range of 300.000-1.000.000 stress cycles.

7. The method of claim 5, wherein the supplying of anti-wear additives to the lubrication oil is performed automatically.

8. The method of claim 5, wherein the anti-wear additives comprise at least one of molybdenum, zinc, phosphor and sulphur.

9. A lubrication assembly for containing lubrication oil, the lubrication assembly comprising:
an anti-wear additive storage;
a releaser configured for releasing anti-wear additive from the anti-wear additive storage into the lubrication oil after an initial period of operation.

10. The lubrication assembly according to claim 9, including:
a controller for controlling the releaser.

11. The lubrication assembly according to claim 10, the controller being configured for measuring the duration of the initial period and for controlling the releaser so as to release the anti-wear additives from the anti-wear additive storage after the duration has reached a release value.

12. The lubrication assembly according to claim 11, wherein the releaser is a valve having a closed and an open condition.

13. The lubrication assembly according to claim 12, including a temperature sensitive member that keeps the valve in the closed condition against a biasing member biasing the valve into the open condition, the temperature sensitive member configured to allow the valve to move from the closed condition to the open condition when the temperature sensitive member has reached a release temperature value.

14. The lubrication assembly according to claim 13, wherein the temperature sensitive member is configured to melt or soften above the release temperature value.

15. The lubrication assembly according to claim 14, wherein the anti-wear additive storage and the releaser are an integral part of an oil filter.

16. An assembly comprising:
a tribosystem having at least one first solid surface and at least one second solid surface that interact when the assembly is in operation; and
a lubrication assembly for lubricating the tribosystem, and including an anti-wear additive storage and a releaser;
the releaser being configured for releasing anti-wear additive from the anti-wear additive storage into the lubrication oil after an initial period of operation of the tribosystem of the assembly.

17. The assembly according to claim 16, including a controller for controlling the releaser, the controller being configured for monitoring a number of stress cycles made by the tribosystem, at least during the initial period of operation of the tribosystem, the controller being configured to activate the releaser for releasing anti-wear additive from the anti-wear additive storage into the lubrication oil after the number of stress cycles has reached a release value.

18. The assembly according to claim 17, wherein the release value is in the range of 300.000 to 1.000.000 stress cycles.
